(19) United States
(12) Patent Application Publication
(10) Pub. No.: US 2010/0129651 A1
(43) Pub. Date: May 27, 2010

(54) HYBRID COMPONENT FOR A GAS-TURBINE ENGINE

(75) Inventor: Karl SCHREIBER, Am Mellensee (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: Rolls-Royce Deutschland Ltd & Co KG, Blankenfelde-Mahlow (DE)

(21) Appl. No.: 12/620,101

(22) Filed: Nov. 17, 2009

(30) Foreign Application Priority Data
Nov. 24, 2008 (DE) 10 2008 058 786.9

(51) Int. Cl. B32B 15/095; B32B 15/04; B32B 5/00

(52) U.S. Cl. 428/339; 428/457; 428/425.8

(57) ABSTRACT

A hybrid component for a gas-turbine engine includes a supporting structure (2) in fiber-composite material and a metallic structure (3) intimately connected to the latter via a thin highly elastic intermediate layer (7) made of thermoplastic polyurethane. The highly elastic material not only provides for a firm connection between the metallic structure and the supporting structure, but also for an absorption of the in-service vibrations and a compensation of the different expansion behavior of the fiber-composite material and the metal. Furthermore, a concentrated load applied to the component by an impinging foreign body is converted by the highly elastic intermediate layer into an area load, thereby substantially reducing the hazard of damaging the supporting structure due to crack formation.

This application claims priority to German Patent Application DE 10 2008 058 786.9 filed Nov. 24, 2008, the entirety of which is incorporated by reference herein.

This invention relates to a hybrid component for a gas-turbine engine, especially a fan blade or a stator vane, including a supporting structure in fiber-composite material as well as a metallic structure fixedly connected to the latter.

In particular, the fan blades of a fan gas-turbine engine are considerably loaded by centrifugal forces, gas pressure and vibrations excited by the flowing medium. Here, the impact effects produced by foreign bodies, for example birds, impinging on the blades are a particular problem.

Fan blades made of a fiber-composite material, which combine low weight with high specific strength and high intrinsic damping to avoid vibrations, are known from specification DE 10 2006 061 915 A1, for example. For adequate erosion resistance and high impact strength against foreign bodies impinging on the blades, e. g. birds, the supporting structure in fiber-composite material is connected to a metallic structure or enclosed by a metallic enveloping structure, respectively. The intimate connection between the supporting structure and the enveloping structure is provided by a prestress between the pressure-side and the suction-side sheet-metal cover and by adhesively bonding the supporting structure to the inner surfaces of the covers. This type of fan blade design, which likewise can also be applied to stator vanes situated downstream of the fan blades, is intended to provide safe connection between the supporting structure and the enveloping structure and avoid reduction of the service life of the blades due to delamination. Still, separation of the supporting structure from the enveloping structure can occur due to vibrations and the different expansion behavior of the fiber-composite material and the metallic material. Furthermore, foreign bodies impinging on the metallic enveloping structure subject the supporting structure to a high load which may result in cracking and consequential reduction of the service life of the blades.

It is a broad aspect of the present invention to provide for the development of hybrid components for a gas-turbine engine, such as fan blades or stator vanes, which feature high damage tolerance and long service life.

The present invention provides that—on a hybrid component, in particular one used as fan blade or stator vane for a gas-turbine engine, with a supporting structure in fiber-composite material and a metallic structure connected to the latter—the supporting structure and the metallic structure are intimately connected via a thin intermediate layer of highly elastic material. The high elasticity of the intermediate layer provides for a firm bond of the intermediate layer to both the supporting structure and the metallic structure, as well as a firm connection between the supporting structure and the metallic structure via the intermediate layer. The different thermal expansion behavior of the fiber-composite material and the metal is compensated by the highly elastic material of the intermediate layer, with in-service vibrations being absorbed, and thereby dampened, by the elastic material. Thus, separation of the metallic structure from the supporting structure is avoided. A further life-increasing effect of the elastic intermediate layer is that a concentrated load applied to the component by an impinging foreign body is not punctiformly and with high intensity transferred to the supporting structure, but converted by the highly elastic intermediate layer into an area load, thereby substantially reducing the hazard of damaging the supporting structure due to crack formation.

In accordance with another important feature of the present invention, the intermediate layer is thermoplastic polyurethane, which is characterized by rubber-like elasticity, good bond and good vibration behavior.

The thermoplastic polyurethane is firmly connected to the inner surface of the metallic structure by injection molding or coating using a mold. The supporting structure is connected to the intermediate layer by an adhesive or, during the manufacture of the supporting structure, immediately by the plastic material freshly infiltrated into the fiber layers.

In accordance with a further feature of the present invention, the elastic intermediate layer is not applied to the highly thermally loaded areas of the metallic structure components to be weldedly joined to prevent the weld from being damaged by the thermoplastic polyurethane which is highly heated in the welding process.

In development of the present invention, the thickness of the intermediate layer preferably ranges between 0.1 and 1.5 mm.

The present invention is more fully described in light of the accompanying drawings showing a preferred embodiment. In the drawings,

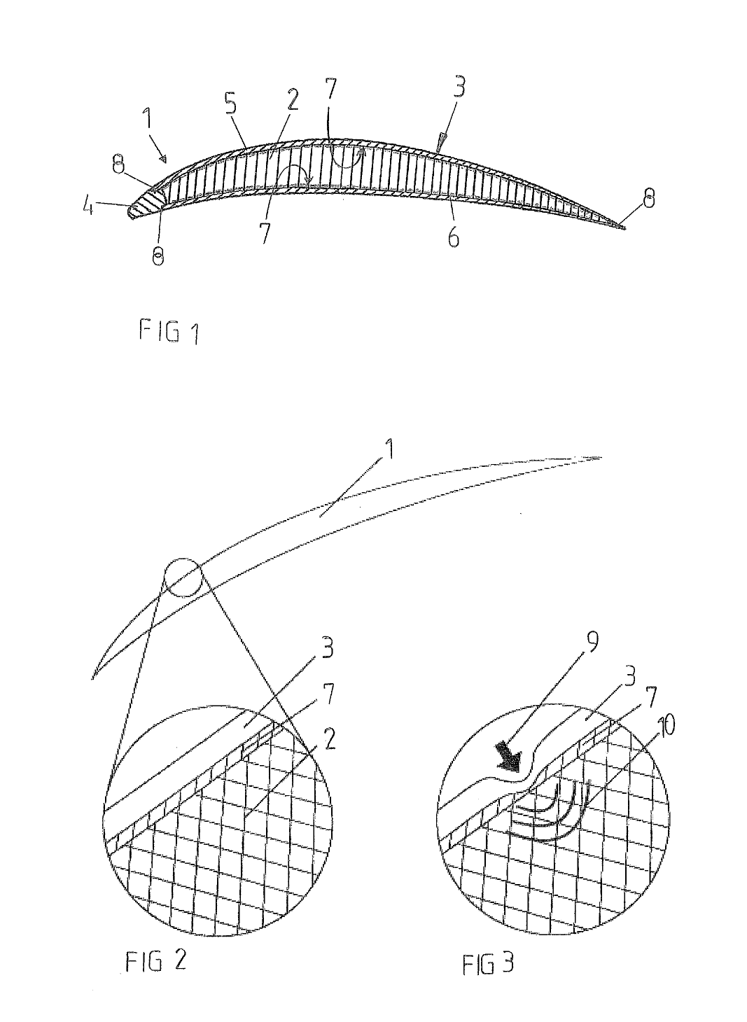

FIG. 1 is a sectional view of the airfoil of a fan blade,

FIG. 2 is an enlarged representation of the transition area between the enveloping and the supporting structure, and

FIG. 3 is a schematic representation of the load distribution, when a foreign body impinges on the metallic enveloping structure of a fan blade.

The fan blade 1 exemplified in the drawing includes a supporting structure 2 in fiber-composite material as well as a metallic structure 3, here a metallic enveloping structure, which includes a solid-metal former 4, which provides the blade leading edge, as well as a suction-side sheet-metal cover 5 and a pressure-side sheet-metal cover 6. The two sheet-metal covers 5, 6 are joined to the former 4 and to each other at the trailing edge of the fan blade 1 via the welds 8. The inner surfaces of the two sheet-metal covers 5, 6 are coated with a highly elastic intermediate layer 7 in thermoplastic polyurethane, which in the present embodiment is 1 mm thick. Except for the region in the immediate vicinity of the welds 8, the entire inner surface of the metallic structure 3 is coated with the thermoplastic polyurethane. Excluding the weld-near regions prevents the weld quality from being impaired by the highly heated thermoplastic polyurethane. The fiber-composite supporting structure 2 of the fan blade is firmly connected to the coated inner surfaces of the metallic structure 3 by means of an adhesive or the plastic infiltrated into the fiber material. The intermediate layer 7 is applied to the sheet-metal covers 5, 6 either by injection molding or by pressing-on and distributing the thermoplastic polyurethane in the form of a plastic mass using a mold whose contour is identical with the contour of the inner surface of the respective sheet-metal cover 5, 6.

Owing to its high elasticity, the intermediate layer 7 in highly elastic thermoplastic polyurethane provides for intimate and firm connection between the metallic structure 3 and the supporting structure 2 in fiber-composite material so that delamination is largely avoided. Furthermore, separation of the connection between metallic structure 3 and supporting structure 2 due to in-service vibrations of the fan blade (or the respective component) is avoided by the vibration-damping effect of the highly elastic intermediate layer 7.

Owing to stress relaxation of the highly elastic thermoplastic polyurethane, the energy dissipation associated with vibration damping and the temperature increase resulting therefrom provide for a decrease in stress.

The different expansion of the metallic structure 3 and the supporting structure 2 in fiber-composite material is compensated by the intermediate layer 7 in thermoplastic polyurethane. In the event of a—locally limited—impact exerted by a foreign body impinging on the metallic structure 3 or a sheet-metal cover 6 as shown in FIG. 3, the concentrated load as per arrowhead 9 is, owing to the elastic properties of the thermoplastic urethane, converted into an area load 10, enabling the hazard of crack formation in the supporting structure 2 to be reduced.

The interplay of the diverse effects of the highly elastic intermediate layer 7 intimately connected to the metallic structure 3 and the supporting structure 2 finally gives rise to a substantial increase in damage tolerance and service life of the hybrid component, here the fan blade 1.

### LIST OF REFERENCE NUMERALS

1 Fan blade

2 Supporting structure

3 Metallic structure, metallic enveloping structure

4 Former of 3

5 Suction-side sheet-metal cover of 3

6 Pressure-side sheet-metal cover of 3

7 Highly elastic intermediate layer (thermoplastic polyurethane)

8 Weld

9 Concentrated load

10 Area load

What is claimed is:

1. A hybrid component for a gas-turbine engine, comprises:
an internal supporting structure of fiber-composite material;
an external metallic structure fixedly connected to the supporting structure; and
an intermediate layer of highly elastic material positioned between the supporting structure and the metallic structure.

2. The hybrid component of claim 1, wherein the intermediate layer is made of a thermoplastic polyurethane and is firmly connected to an inner surface of the metallic structure facing the supporting structure.

3. The hybrid component of claim 2, and further comprising an adhesive connecting the supporting structure to the highly elastic intermediate layer.

4. The hybrid component of claim 2, wherein the intermediate layer is infiltrated into the fiber-composite material.

5. The hybrid component of claim 4, wherein the elastic intermediate layer is not applied to areas of the metallic structure which will be welded.

6. The hybrid component of claim 3, wherein the elastic intermediate layer is not applied to areas of the metallic structure which will be welded.

7. The hybrid component of claim 1, wherein a thickness of the intermediate layer approximately ranges between 0.1 and 1.5 mm.

8. The hybrid component of claim 2, wherein a thickness of the intermediate layer approximately ranges between 0.1 and 1.5 mm.

9. The hybrid component of claim 3, wherein a thickness of the intermediate layer approximately ranges between 0.1 and 1.5 mm.

10. The hybrid component of claim 4, wherein a thickness of the intermediate layer approximately ranges between 0.1 and 1.5 mm.

11. The hybrid component of claim 5, wherein a thickness of the intermediate layer approximately ranges between 0.1 and 1.5 mm.

12. The hybrid component of claim 6, wherein a thickness of the intermediate layer approximately ranges between 0.1 and 1.5 mm.

13. The hybrid component of claim 1, and further comprising an adhesive connecting the supporting structure to the highly elastic intermediate layer.

14. The hybrid component of claim 1, wherein the intermediate layer is infiltrated into the fiber-composite material.

15. The hybrid component of claim 1, wherein the elastic intermediate layer is not applied to areas of the metallic structure which will be welded.

16. The hybrid component of claim 1, wherein the component is at least one of a stator vane and a fan blade.
